(19) United States
(12) Patent Application Publication
(10) Pub. No.: US 2007/0103712 A1
(43) Pub. Date: May 10, 2007

(54) System and method for limiting access to a shared multi-functional peripheral device based on preset user privileges

(76) Inventor: Fatima Corona, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/266,786

(22) Filed: Nov. 4, 2005

(51) Int. Cl. G06K 15/00

(52) U.S. Cl. 358/1.14; 358/1.15

(57) ABSTRACT

A system and method for restricting access to a shared MFP is disclosed. The system includes an administration module, an authentication module and a shared MFP connected to the authentication module. The administration module creates and updates user profiles, which include user identification information and user privilege information. The shared MFP receives a request from a user for an operation, which is transmitted to the authentication device. Then, the authentication device determines whether the user is authorized to use the shared MFP using the user identification information of the at least one user profile. If the user is authorized, the authentication device determines whether the requested operation is permitted to the user using the user privilege information of the at least one user profile. If the requested operation is permitted, the authentication device instructs the shared MFP to process the requested operation.

### CROSS-REFERENCE TO RELATED APPLICATIONS

This application is related to U.S. patent application Ser. No. ______, filed concurrently herewith (Attorney Docket No. SAMINF.019A) and entitled “SYSTEM AND METHOD FOR LIMITING ACCESS TO A SHARED MULTI-FUNCTIONAL PERIPHERAL DEVICE,” which is hereby incorporated by reference herein.

### BACKGROUND OF THE INVENTION

1. Field of the Invention

The invention relates to the operation of a shared multi-function peripheral (MFP) device. More particularly, the invention relates to restricting access to different operations of a shared MFP device.

2. Description of the Related Technology

Currently, many computerized office equipment and computer peripheral devices are shared by two or more people in a business environment. Such sharing has been facilitated by networking of computers and computerized devices including office machines and computer peripheral devices. The sharing of office machines and peripheral devices has created a need to limit the access to network devices only to certain users, such as employees of the businesses.

### SUMMARY OF CERTAIN INVENTIVE ASPECTS

The need to limit access to network devices only to certain users is addressed by providing methods for restricting access to a shared Multi-Function Peripheral (MFP). In one embodiment, the method comprises providing a profile that identifies at least one shared MFP operation permitted to a user; receiving a request from the user to execute a shared MFP operation; determining whether the user's profile permits the shared MFP operation; and, if the shared MFP operation is permitted to the user, instructing the shared MFP to execute the shared MFP operation.

In other embodiments, the profile may comprise user authentication information and user privilege information. Moreover, the user authentication information may comprise at least one of a user name, a user ID, a department name, a password, a fingerprint, a voice recording, and an iris pattern. In the case that the profile comprises user authentication information, the determination of whether the user's profile permits the shared MFP operation may comprise receiving information identifying the user provided by the user and comparing the user-provided information with the user authentication information of the user's profile. Furthermore, the user privilege information may comprise at least one of a list of shared MFP operations permitted to the user and a list of shared MFP operations not permitted to the user. In the case that the profile comprises user privilege information, the determination of whether the user's profile permits the shared MFP operation may comprise accessing the user privilege information of the user's profile and determining whether the shared MFP operation is identified as a permitted operation in the user privilege information.

In still other embodiments, the method may further comprise notifying the user of a result of the determination of at least one of: (1) whether the user is authorized and (2) whether the shared MFP operation is permitted. In the case that the user is authorized and the shared MFP operation is denied, the method may further comprise notifying the user of a reason for the denial. In yet other embodiments, the profile may comprise information as to whether the user is permitted to use the shared MFP with regard to at least one of printing, copying, scanning, and faxing. The profile may also comprise information as to whether the user is authorized to use the shared MFP with regard to at least one of the following operations: black/white printing, black/white copying, black/white scanning, black/white faxing, color printing, color copying, color scanning, color faxing, stapling, duplex, emailing, folder, and FTP. Additionally, providing the profile method may comprise updating the profile.

The need to limit access to network devices only to certain users is also addressed by providing a system for selectively processing a request for a shared MFP operation. In one embodiment, the system comprises a shared MFP configured to receive a request from a requester for an operation thereof, the shared MFP being configured to selectively process the requested operation if the requested operation is permitted to the requester; and an authentication device in data communication with the shared MFP, the authentication device being configured to determine whether the requested operation is permitted to the requester.

In another embodiment, the system further comprises an input device to receive information identifying the requester, wherein the input device comprises a stand-alone device connected to the office machine or a module integrated with the office machine. The input device may be configured to receive at least one of a user name, a user ID, a department name, a password, a fingerprint, a voice recording, and an iris pattern.

In still another embodiment, the shared MFP is configured to perform at least one of printing, copying, scanning and faxing, and the authentication device is configured to determine whether the requester is permitted to use the office machine to perform at least one of the printing, copying, scanning and faxing. The shared MFP may also be configured to perform at least one of black/white printing, black/white copying, black/white scanning, black/white faxing, color printing, color copying, color scanning, color faxing, stapling, duplex, emailing, folder, FTP.

In yet another embodiment, the system further comprises a memory storing at least one user profile comprising user authentication information and user privilege information, wherein the authentication device is configured to access the at least one user profile to authenticate the requestor and to determine whether the requested operation is permitted to the requestor. The system may further comprise an administration device in data connection with the authentication device, the administration device being configured to create or modify the at least one user profile.

In other embodiments, the authentication device may be integrated with the shared MFP. Alternatively, the authentication device may be connected to the shared MFP via an information network or a dedicated connection. In still other embodiments, the shared MFP and the authentication device may be further configured to communicate via a shared protocol. Additionally, the shared MFP and the authentication device may be further configured to encrypt and decrypt data communications.

The need to limit access to network devices only to certain users is also addressed by providing a computer readable medium having machine loadable software for selectively permitting a request for a shared MFP operation. In one embodiment, the software is configured to perform a method comprising creating at least one profile, each profile comprising information that identifies at least one shared MFP operation permitted to a user; for each request by the user to execute a shared MFP operation, determining whether the user's profile permits the shared MFP operation.

In another embodiment, creating at least one profile may comprise creating user privilege information based on functions and features of a shared MFP with which the software is used. Additionally, creating at least one profile may comprise inputting user identification information in at least one format selected from the group consisting of text, image, and sound. In still another embodiment, the method may further comprise notifying the shared MFP of a result of the determination of at least one of: (1) whether the user is authorized and (2) whether the shared MFP operation is permitted. In yet another embodiment, the software may be installable and executable in a computer connected to the office machine. Alternatively, the software may be installable and executable in the shared MFP.

The need to limit access to network devices only to certain users is also addressed by providing a method of restricting access to a shared printing device. In one embodiment, the method comprises providing a profile that identifies at least one shared printing device operation 1 to a user; receiving a request from the user to execute a shared printing device operation; determining whether the user's profile permits the shared printing device operation; and, if the shared printing device operation is permitted to the user, instructing the shared printing device to execute the shared printing device operation.

### BRIEF DESCRIPTION OF THE DRAWINGS

FIG. 1 illustrates a system for limiting use of a peripheral device by a user only to functions authorized to the user in accordance with an embodiment of the invention.

FIG. 2 is a flowchart of a setup process for restricting access to a peripheral device and its operation in accordance with an embodiment of the invention.

FIG. 3 is a flowchart of creating a new user profile in accordance with an embodiment of the invention.

FIG. 4 is an administration module interface for setting up or updating user profiles in accordance with an embodiment of the invention.

FIG. 5 is a flowchart of operation of the system and method to authenticate a user to access a peripheral device and restrict its use by the user in accordance with an embodiment of the invention.

FIG. 6 is a flowchart of authenticating a user and creating user access information in accordance with an embodiment of the invention.

FIG. 7 is a flowchart of executing a requested operation in accordance with an embodiment of the invention.

FIG. 8 is another embodiment of the invention for limiting use of a peripheral device by a user only to functions authorized to the user.

### DETAILED DESCRIPTION OF EMBODIMENTS

Various aspects and features of the invention will become more fully apparent from the following description and appended claims taken in conjunction with the foregoing drawings. In the drawings, like reference numerals indicate identical or functionally similar elements. The drawings, associated descriptions, and specific implementation are provided to illustrate embodiments of the invention and not to limit the scope of the disclosure.

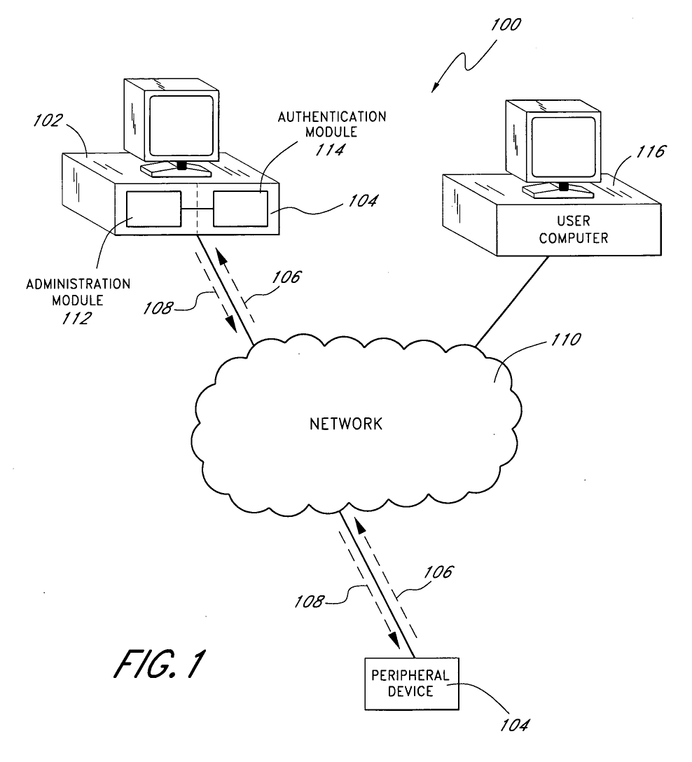

FIG. 1 illustrates a system 100 according to an embodiment of the invention, in which a user's use of a peripheral device is limited to only those functions or features authorized to the specific user. In the illustrated embodiment, a networked computing device 102 and a peripheral device 104 communicate with each other through a network 110. In particular, the peripheral device 104 sends the data transmission 106 to the networked computing device 102 through the network 110, and the computing device 102 sends the data transmission 108 to the peripheral device 104 through the network 110. In the illustrated embodiment, the computing device 102 comprises an administration module 112 and an authentication module 114.

Briefly describing the overall operation of the system 100, the peripheral device 104 receives a request for an operation from a user (not shown) at the peripheral device 104 or from a computer connected to it. To gain access to the requested operation, the user is required to provide the peripheral device 104 with information that identifies the user (user authentication information). Then, the peripheral device 104 transmits the user authentication information and information identifying the requested operation (requested operation information) to the authentication module 114 of the computing device 102 via the data transmission 106. Then, the authentication module 114 determines whether the user is authorized to access the requested operation using the user authentication information, the requested operation information and pre-stored information (user profiles) that specifies authorized users for the peripheral device and authorized operations of each authorized user. The authentication module 114 then transmits the determination (user access information) to the peripheral device 104 via the data transmission 108. The peripheral device 104 receives and operates according to the user access information. The administration module 112 is used to create and update the user profiles.

The administration module 112 and the authentication module 114 respectively may comprise one or more software programs that are executed by one or more processors of the computing device 102. For example, the processor may have a configuration based on Intel Corporation's family of microprocessors, such as the Pentium family. In other embodiments, the administration module 112 and the authentication module 114 respectively may comprise logic or software instructions embodied in hardware or firmware. It will be further appreciated that hardware may be comprised of connected logic units, such as gates and flip-flops, and/or may be comprised of programmable units, such as EPROM, EEPROM, programmable gate arrays or processors. Further, the hardware may comprise a stand-alone dedicated device or general purpose computer with executable software.

It is also contemplated that components of the administration module 112 and the authentication module 114 respectively may be integrated in different forms. For example, the administration module 112 may include components that can be separated into several subcomponents or that can be separated into more devices or sets of software code that reside at different locations and that communicate with each other, such as through a wired or wireless network.

The peripheral device 104 can be any suitable office machine or device that can communicate with a computerized device, e.g., the computing device 102 via a network. The peripheral device 104 performs one or more functions including scanning, copying, printing, faxing, combinations of the same and the like. In certain embodiments, the peripheral device 104 advantageously comprises a multi-functional peripheral (MFP) device, which includes a single integrated device configured to perform two or more of these functions. For example, the MFP device may perform printing, copying, scanning, faxing, combinations of the same and the like. Further, for each primary function, the MFP device may execute any number of function-specific features. For instance, for the copying or printing function the MFP device may print in either black/white or color, may staple pages together, or may print on both sides of the paper. Each option is a device feature specific to the particular MFP function. Similarly, for the scanning function the MFP device may send the scanned object in the text of an email or as an attachment, may send to local folder or to a shared directory, or may send the document remotely through an FTP connection. Finally, for the faxing function the MFP device may send the faxed object over the Internet of a Local Area Network. The details of the inner workings of scanning/printing peripheral devices are various and well known and will not be further described.

In another embodiment, the peripheral device 104 of FIG. 1 may be replaced with an aggregate of a plurality of machines or devices, each of which can perform one or more functions including scanning, copying, printing, faxing, combinations of the same and the like. In this embodiment, each of the devices may communicate with the computing device 102 individually. Alternatively, the aggregated devices may be connected to a control device (not shown), which communicates with the computing device 102. The control device may be a server of a network interconnecting the plurality of the devices. In another embodiment, the control device may be part of one of the plurality of devices.

In another embodiment, the peripheral device 104 of FIG. 1 may be a single-function peripheral device, such as a printer, copier, scanner, or fax machine. In this embodiment, the authentication module 114 determines whether a user is permitted to access a function-specific feature, such as black/white, color, staple, duplex, email, folder, FTP, etc.

In another embodiment, the computing device 102 and the peripheral device 104 communicate the data transmissions 106 and 108 via a shared protocol. This protocol may be a common protocol, such as TCP/IP, or a completely private protocol for a specific peripheral device, or it may be a combination of both. In yet another embodiment, the data transmissions 106 and 108 are communicated via a standard encryption method such as SSL. One skilled in the art, however, will appreciate that any encryption method, including private encryption methods, may be employed.

In the illustrated embodiment, the network 110 can be any suitable form of information network interconnecting various computers, computerized devices, and network devices. In one embodiment, the network may be replaced with a dedicated connection between the peripheral device 104 and the computing device 102. The network 110 may have either or both wired and wireless connections.

Setup of the System

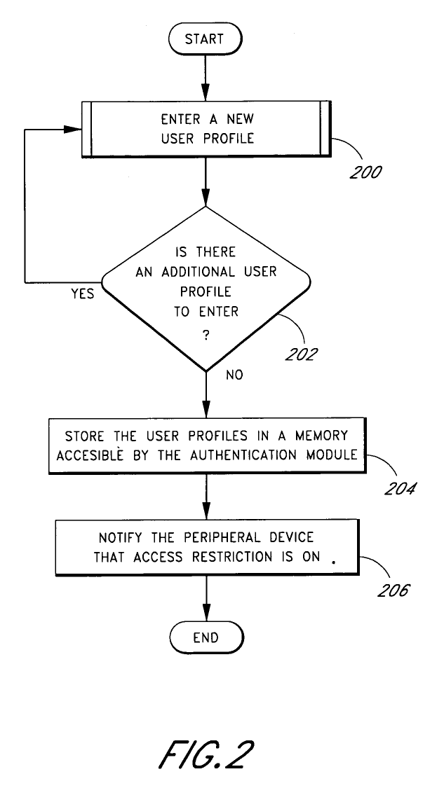

FIG. 2 illustrates an embodiment of a procedure setting up restricted access to the operations of peripheral device 104. First, in state 200, an administrator of the system uses the administration module 112 to create profiles of users who are authorized to use the peripheral device 104, referred to as user profiles, which will be discussed in more detail below. As contemplated in FIG. 1, the administrator may access the administration module 112 through the standard interface of the computing device 102. In other embodiments, the administrator may access the administration module 112 in the computing device 102 from another networked computing device connected to the network 110, e.g., user computer 116, or from the peripheral device 104.

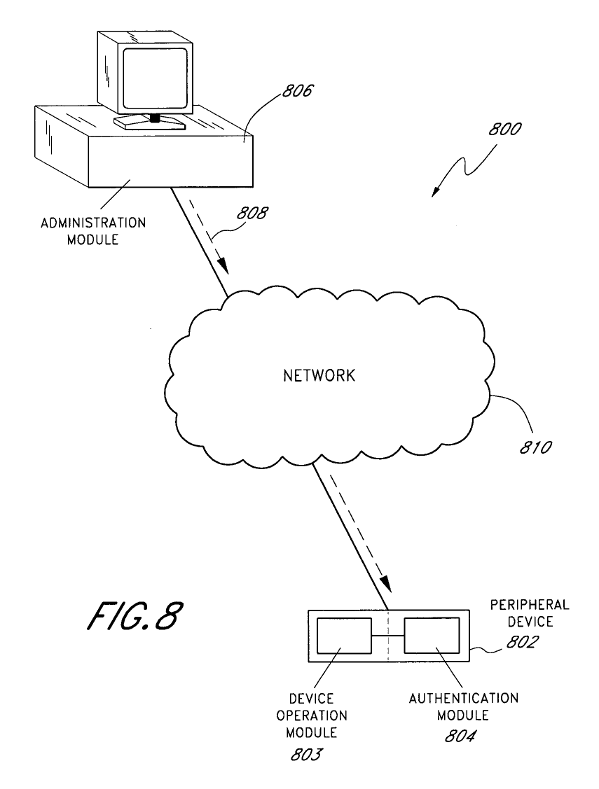

After a complete user profile has been created, an administrator may create another user profile, as indicated at state 202. Once the administrator finishes entering user profiles, in state 204, the administration module 112 stores the user profiles in a memory accessible by the authentication module 204. It will be appreciated by those skilled in the art that each user profile may be stored immediately after being entered by the administrator, or at any time thereafter, rather than waiting to store all the newly entered user profiles at once, as in the illustrated embodiment. When the administration module 112 and the authentication module 114 operate on the same computing device 102, as illustrated in FIG. 1, then in state 204 the user profiles are stored to a local memory of the computing device 102. In other embodiments, state 204 may comprise transmitting through the network 110 the user profiles to another networked device on which an authentication module 114 operates. (See, for example, the embodiment illustrated by FIG. 8.) Finally, in state 206, the administration module 112, at the command of an administrator or automatically, notifies the peripheral device 104 that the access restriction function is turned on. From this point, the peripheral device 104 will not execute an operation until the authentication module 114 authenticates that the user requesting an operation is privileged to use the particular operation.

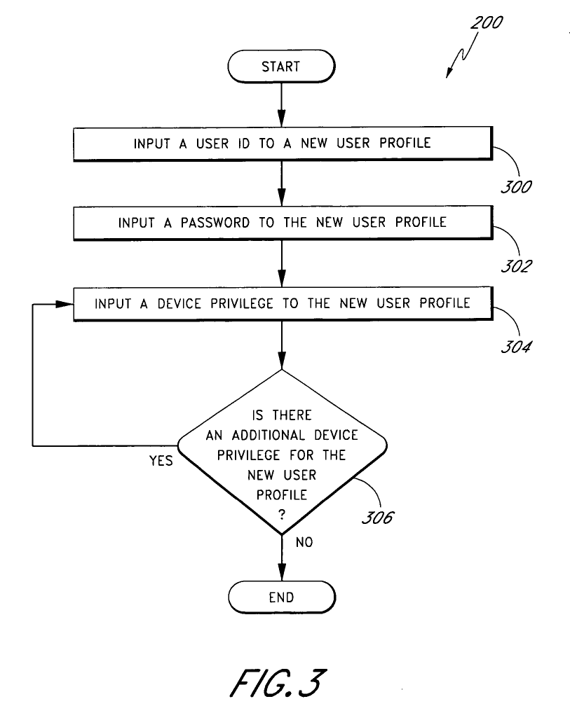

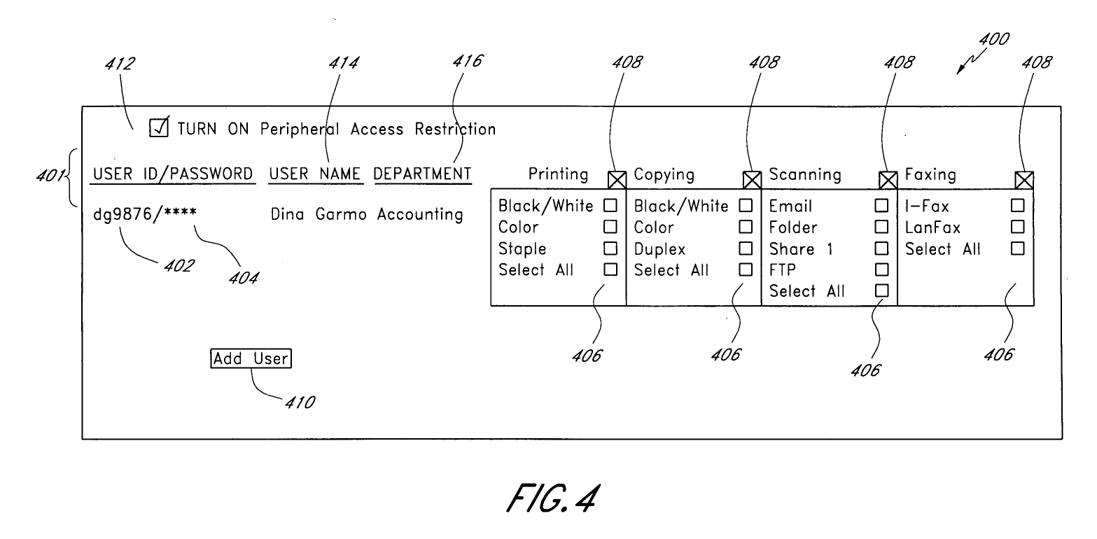

FIG. 3 illustrates an embodiment of state 200 of FIG. 2 for entering a new user profile. As explained above, an administrator uses the administration module 112 to enter the new user profiles. In one embodiment, the administration module 112 is accessed by authorized administrators only, such as system administrators. For example, access to the administration module 112 is password-protected. The administrator communicates with the administration module 112 through an administrator interface, an embodiment of which will be described with reference to FIG. 4 below.

Typically, the administrator obtains or collects information to enter into a user profile prior to entering new user profiles or even prior to accessing the administration module 112. In one embodiment, the information includes a user ID and name of a user who is authorized to use the peripheral device 104. The information further includes privileges of the authorized user in the operations of the peripheral device 104, which will be described in more detail. In another embodiment, the information may further include a password of the user for use when accessing the peripheral device. The information may be created by the system administrator or obtained from a manager or another staff of the organization using the system.

Once an administrator accesses the administrator interface, in state 300, the administrator inputs a user ID of the authorized user to a new user profile. It will be appreciated by those skilled in the art that the user profile may be a statically or dynamically allocated memory object or objects with separate fields, including, e.g., a user ID. Subsequently, in state 302, the administrator inputs a password associated with the user ID to the new user profile. Although not illustrated, in certain embodiments, the user profile may comprise fields for a fingerprint, a voice recording, or an iris pattern of the user. Finally, in state 304, an administrator inputs a privilege applicable to the authorized user to the new user profile. After entering one device privilege, in state 306, the administrator returns to state 304 to enter an additional device privilege until there is no additional device privilege to enter.

The term “device privilege” refers to information that identifies device functions or features that the authorized user is permitted or restricted to use upon authentication. The device privileges may identify device functionality, such as printing, copying, scanning, faxing, etc. For example, a user may be restricted from copying and faxing, while being permitted to use the printing and scanning functions. The device privileges may also identify device features pertaining to device functionality. For instance, in printing or copying function, the device privileges may identify features such as black/white, color, staple, etc. Thus, a user authorized to use the printing function may be authorized to print only in black and white, not in color, if his/her privilege dictates so. Further, device privileges may identify device features such as email, folder, FTP, etc. of the scanning functionality. In faxing functionality, for instance, device privileges may identify features such as Internet fax (I-Fax), analog fax (LanFax), etc.

FIG. 4 illustrates an embodiment of an administrator interface 400 for using the administration module 112. In the illustrated embodiment, the administrator may create a new user profile by entering information in some or all of the fields appearing on the interface 400 and/or any other required fields. For example, the user ID field 402 and the password field 404 may be required to create a new user profile. The administrator may enter device privileges including device functionality and device features. In the illustrated embodiment, the device functionality can be selected by checking one or more boxes 408. The device features are also selected by checking one or more boxes 406 under each of the device functionality boxes 408. In one embodiment, when a particular device feature is selected, the corresponding device functionality may be automatically selected. For example, if the administrator selects I-Fax, the box for the scanning may be checked. In yet another embodiment, when the “Select all” feature is selected, all of the features for that particular functionality are selected.

In one embodiment, when the administrator selects the “Add User” button 410, the new user profile 401 is stored in the local memory of the computing device 102. In other embodiments, when the administrator selects the add user button 410, the user profile 401 is transmitted to a computing device incorporating the authentication module 114 through the network 110. In the illustrated embodiment, the administrator chooses whether to turn on access restriction to the peripheral device 104 by selecting the on/off button 412. In other embodiments, access restriction may be turned on automatically when at least one user profile has been entered. In the illustrated embodiment, the administrator may enter the name of the user and his/her department information to the user name field 414 and the department name field 416, respectively. In one embodiment, the administrator may enter device privileges for the members of an entire department, restricting all users in the same department to only the permissible device functionality and features.

It will be appreciated by one skilled in the art that the setup procedure may also be used to periodically update the stored list of user profiles. Thus, new user profiles may be added at any time, and the setup procedure may be repeated as necessary. Furthermore, one skilled in the art will realize that stored user profiles may be modified as necessary.

Restricting Operation of a Peripheral Device

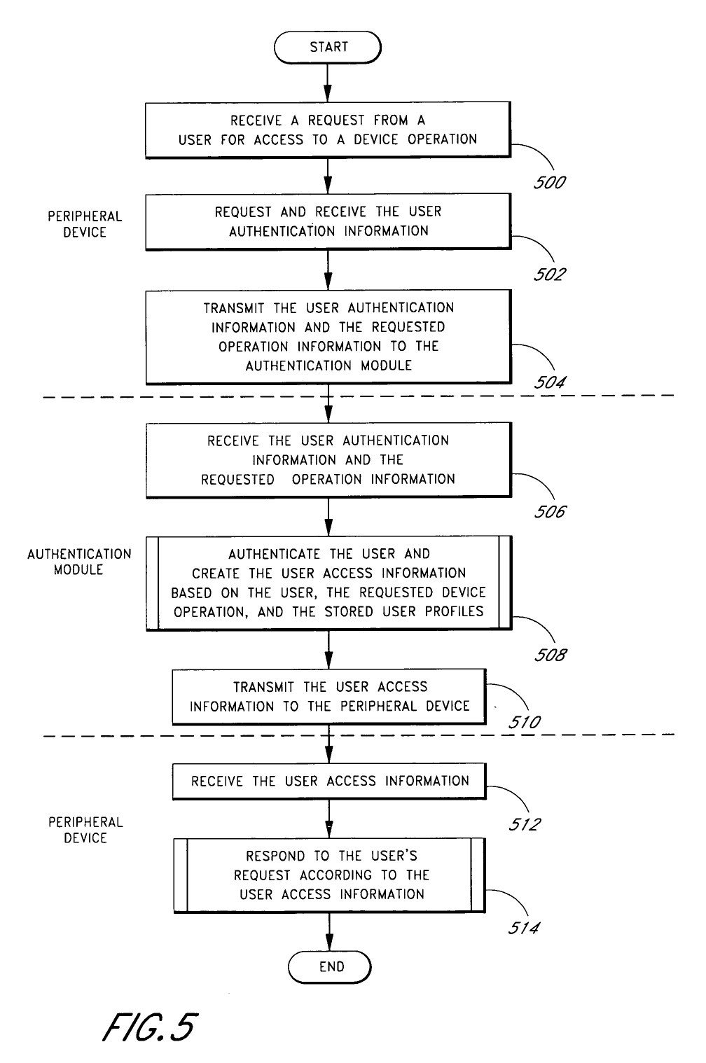

FIG. 5 illustrates an embodiment of a procedure for restricting access to a peripheral device and its operations. First, in state 500, the peripheral device 104 receives a request from a user for a particular device operation. The user may make the request to the peripheral device 104 from a location remote from it or at the peripheral device 104. For example, the user can make a printing request from a computer connected to the peripheral device 104 via the network 110. Also, the user can make a copying request at the peripheral device 104 by placing an original document on a copying surface of the device.

Then, in state 502, the peripheral device 104 receives authentication information from the user. In one embodiment, upon receiving the device operation request at state 500, the user interface of the peripheral device 104, or a computer connecting to the peripheral device, may request that the user input authentication information. In another embodiment, the user may be prompted to provide authentication information to make the device operation request at state 500. In one embodiment, the user authentication information includes a user ID and a password of the user. In another embodiment, the user authentication information may comprise a fingerprint, a voice recording, or an iris pattern of the user. One or more appropriate input devices that can receive the authentication information is provided at the peripheral device 104 or the computer connecting to the peripheral device 104.

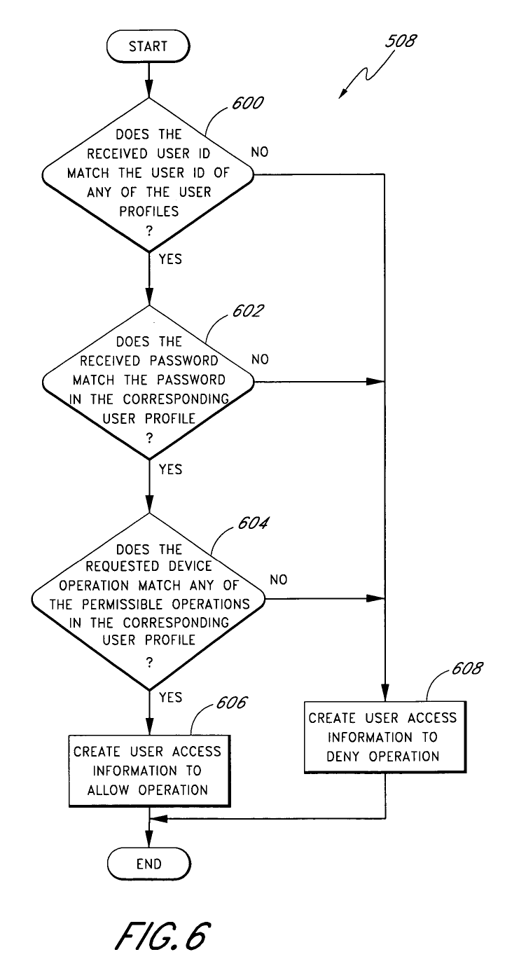

Next, in state 504, the peripheral device 104 transmits the user authentication information (see dashed arrows 106 in FIG. 1) and the requested operation information to the authentication module 114. Once authentication module 114 receives the user authentication information, the authentication module 114, in state 508, proceeds to authenticate the user based on the user authentication information and stored user profiles. Further, in state 508, the authentication module 114 creates user access information based on the authentication result, the requested operation information, and the stored user profiles. The process of authentication and creating user access information will be described in more detail with reference to FIG. 6.

In state 510, the authentication module 114 transmits the user access information (see the dashed arrows 108 in FIG. 1) to the peripheral device 104. The peripheral device 104 receives the user access information, in state 512. Then, in state 514, the peripheral device 104 responds to the user's request for the device operation request received at state 500. For example, if the requested device operation is approved, the peripheral device 104 executes the requested device operation.

In one embodiment, the user need not be authenticated for each requested device operation once authenticated. For instance, if a user requests to use the scanning function, and then chooses to email the scanned document, the peripheral device 104 does not need to request that the user provide authentication information a second time. In one embodiment, the peripheral device 104 may be configured to allow the user to be logged in for a predetermined period, e.g., a certain amount of time. In another embodiment, the peripheral device 104 may allow a predetermined number of consecutive operations, each of which is requested within a predetermined period after the immediately previous request or the completion of the immediately previous operation. Accordingly, the authentication module 114 may skip the instruction to authenticate the user, and proceed to determine whether the second or following request is within the device privileges of the logged-in user. In particular, in this embodiment, it is unnecessary to perform states 502, 506 and 508.

FIG. 6 illustrates an embodiment of state 508 of FIG. 5, in which the authentication module 508 authenticates the user and creates the user access information. First, in state 600, the authentication module 114 determines whether the user ID from the user authentication information matches the user ID of any of the stored user profiles. In an embodiment where the user authentication information includes more than the user ID, the authentication module 114 parses the user ID from the user authentication information prior to performing state 600. If there is a match, then the authentication module 114 proceeds to state 602, otherwise the authentication module 114 proceeds to state 608.

In state 602, the authentication module 114 determines whether the password from the user authentication information matches the password in the user profile identified in state 600. This state 602 may also involve parsing the password from the user authentication information. If there is a match, then the authentication module 114 proceeds to state 604, otherwise the authentication module 114 proceeds to state 608. Although not illustrated, if the authentication information includes additional security information such as a fingerprint, a voice recording and/or an iris pattern, the authentication module 114 may also conduct a determination whether the additional security information matches corresponding information stored in the user profile identified in state 600 (matching user profile).

In state 604, the authentication module 114 determines whether the requested operation matches any of the permissible operations (device privileges) stored in the matching user profile. In addition or in the alternative, the authentication module 114 may determine whether the requested operation is restricted according to the device privilege in the matching user profile. If the requested operation information is a permissible operation and is not restricted, then the authentication module 114 proceeds to state 606, otherwise the authentication module 114 proceeds to state 608.

In state 606, the authentication module 606 creates user access information that notifies the peripheral device 104 that the device operation requested by the user is approved. It will be appreciated by one skilled in the art, that the user access information may be created in any suitable way. For example, the authentication module 606 may allocate memory for a Boolean variable and assign the appropriate value. If the authentication module 114 did not find a match in state 600, 602, or 604, then the authentication module 114 proceeded to state 608. In state 608, the authentication module 114 creates user access information that notifies the peripheral device 104 that the device operation requested by the user is denied.

As mentioned previously with reference to FIG. 5, in some embodiments, it may be unnecessary to authenticate a user that is already logged in. In such embodiments, states 600 and 602 are unnecessary, and the authentication module 114 may begin with state 604, which determines whether the device operation requested by the user is approved according to the device privileges in the corresponding user profile.

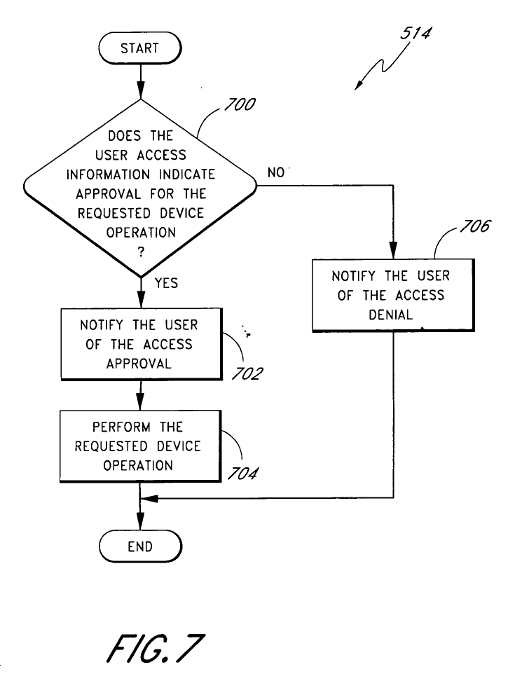

FIG. 7 illustrates an embodiment of state 514 of FIG. 5, in which the peripheral device responds to the user's device operation request received at state 500. In state 700, the peripheral device 104 determines whether the user access information received from the authentication module 114 indicates approval for the requested device operation. If the requested device operation was approved, the peripheral device 104 proceeds to state 702, otherwise the peripheral device proceeds to state 706. In state 702, the peripheral device 104 notifies the user of the approval of the requested operation. Then, in state 704, the peripheral device 104 performs the requested device operation. In the alternative, the notification may be made after initiating the approved device operation, or the notification may not be given at all, only in the case of access being denied.

In state 700, if the peripheral device determines that. the user access information did not approve the requested user operation, then the peripheral device proceeded to state 706. In state 706, the peripheral device 104 notifies the user that the requested device operation is denied. In one embodiment, the peripheral device 104 may further notify the user of the reasons for the denial of the requested operation. For example, the reasons may include “no matching user ID,” “incorrect password,” “no privilege for the requested operation,” etc. Further, in another embodiment, if the only reason for the denial is that the user does not have a privilege to the requested operation, the peripheral device 104 may further notify the user of the current privilege information. In the embodiment where the peripheral device 104 notifies the reasons for denial and/or the current privilege, the authentication module 114 supplies the corresponding information to the peripheral device 104 when it determines that the requested operation is denied. In other embodiments, the user access information, received previously, may already indicate the device privileges. In these embodiments, the peripheral device 104 determines whether access can be approved by searching for the requested device operation among the list of device privileges of the user, as described in more detail below.

The notification at states 704 and 706 may be made in various ways, which the skilled artisan will readily appreciate. The approval information may be displayed on a display screen or panel of the peripheral device 104. In addition or in the alternative, the approval information may be notified by sound. In case the user attempts to access the peripheral device from a computer connected to the peripheral device 104, the notification may be made by a pop-up window, an e-mail to the user, etc.

Although the user access information may be a simple Boolean variable, it may comprise a list of device operations that the peripheral device 104 may operate in certain embodiments. In such embodiments, the authentication module 114 does not perform the state 604 of FIG. 6 and rather provides in the user access information the entire list of permissible operations. The state 604, which determines whether the requested operation is permitted, is performed by the peripheral device 104 using the list of permissible operations provided from the authentication module 114. Thus, the peripheral device 104 parses the list of permissible device operations and compares the requested operation with the list of permissible operations. If the requested operation matches one of the permissible operations, then the peripheral device 104 proceeds to state 702, and otherwise the peripheral device 104 proceeds to state 706.

Peripheral Authentication System

FIG. 8 illustrates a system 800 for restricting the use of a peripheral device in accordance with an embodiment of the invention. In the illustrated embodiment, a peripheral device 802 includes a device operation module 803 and an authentication module 804. The device operation module 803 corresponds to the peripheral device 104 of the embodiment of FIG. 1. The authentication module 804 corresponds to the authentication module 114 of the embodiment of FIG. 1. The peripheral device 802 communicates with an administration module 806, for example, via a network 810. In particular, the administration module 806 transmits user profile data 808 to the authentication module 804 of the peripheral device 802, for example, via the network 810.

Unlike the embodiment illustrated in FIG. 1, in the embodiment illustrated in FIG. 8, the peripheral device 802 and the authentication module 804 do not communicate via a network 810. However, other than the aspect of network communication, the authentication module 804 communicates with the device operation module 803 as the authentication module 114 communicates with the peripheral device 104 in the embodiment of FIG. 1. Further, the administration module 806 and the authentication module 804 communicate via a shared protocol through the network 810. During the setup (see FIG. 2), the administration module 806 transmits all of the user profiles entered by an administrator to the authentication module 804.

In another embodiment, not illustrated, the administration module 806 may reside on the peripheral device 802, for example, as embedded web server software. Alternatively, the administration module 806 may also reside on a separate computing device, not embedded in the peripheral device 802, and this administration module 806 would have the ability, in addition to creating the user profiles, to download the profiles to the authentication module 804. In these alternative embodiments, an administrator could also access the administration module 806 from a remote computer through the network 810.

What is claimed is:

1. A method of restricting access to a shared MFP, the method comprising:
providing a profile that identifies at least one shared MFP operation permitted to a user;
receiving a request from the user to execute a shared MFP operation;
determining whether the user's profile permits the shared MFP operation; and
if the shared MFP operation is permitted to the user, instructing the shared MFP to execute the shared MFP operation.

2. The method of claim 1, wherein the profile comprises user authentication information and user privilege information.

3. The method of claim 2, wherein the user authentication information comprises at least one of a user name, a user ID, a department name, a password, a fingerprint, a voice recording, and an iris pattern.

4. The method of claim 2, wherein the user privilege information comprises at least one of a list of shared MFP operations permitted to the user and a list of shared MFP operations not permitted to the user.

5. The method of claim 1, wherein the profile comprises user authentication in formation and wherein determining comprises receiving information identifying the user provided by the user, and comparing the user-provided information with the user authentication information of the user's profile.

6. The method of claim 1, wherein the profile comprises user privilege information and wherein determining comprises accessing the user privilege information of the user's profile and determining whether the shared MFP operation is identified as a permitted operation in the user privilege information.

7. The method of claim 1, further comprising notifying the user of a result of the determination of at least one of: (1) whether the user is authorized and (2) whether the shared MFP operation is permitted.

8. The method of claim 7, wherein if the user is authorized and the shared MFP operation is denied, the method further comprises notifying the user of a reason for the denial.

9. The method of claim 1, wherein the profile comprises information as to whether the user is permitted to use the shared MFP with regard to at least one of printing, copying, scanning, and faxing.

10. The method of claim 1, wherein the profile comprises information as to whether the user is authorized to use the shared MFP with regard to at least one of the following operations: black/white printing, black/white copying, black/white scanning, black/white faxing, color printing, color copying, color scanning, color faxing, Internet faxing, analog faxing, duplex printing, duplex copying, stapling, emailing, folder, and FTP.

11. The method of claim 1, wherein providing the profile comprises updating the profile.

12. A system for selectively processing a request for a shared MFP operation, the system comprising:
a shared MFP configured to receive a request from a requestor for an operation thereof, the shared MFP being configured to selectively process the requested operation if the requested operation is permitted to the requester; and
an authentication device in data communication with the shared MFP, the authentication device being configured to determine whether the requested operation is permitted to the requestor.

13. The system of claim 12, further comprising an input device to receive information identifying the requestor, wherein the input device comprises a stand-alone device connected to the office machine or a module integrated with the office machine.

14. The system of claim 13, wherein the input device is configured to receive at least one of a user name, a user ID, a department name, a password, a fingerprint, a voice recording, and an iris pattern.

15. The system of claim 12, wherein the shared MFP is configured to perform at least one of printing, copying, scanning and faxing, and wherein the authentication device is configured to determine whether the requestor is permitted to use the office machine to perform at least one of the printing, copying, scanning and faxing.

16. The system of claim 12, wherein the shared MFP is configured to perform at least one of black/white printing, black/white copying, black/white scanning, black/white faxing, color printing, color copying, color scanning, color faxing, Internet faxing, analog faxing, duplex printing, duplex copying, stapling, emailing, folder, FTP.

17. The system of claim 12, further comprising a memory storing at least one user profile comprising user authentication information and user privilege information, wherein the authentication device is configured to access the at least one user profile to authenticate the requestor and to determine whether the requested operation is permitted to the requestor.

18. The system of claim 17, further comprising an administration device in data connection with the authentication device, the administration device being configured to create or modify the at least one user profile.

19. The system of claim 12, wherein the authentication device is integrated with the shared MFP.

20. The system of claim 12, wherein the authentication device is connected to the shared MFP via an information network or a dedicated connection.

21. The system of claim 12, the shared MFP and the authentication device being further configured to communicate via a shared protocol.

22. The system of claim 21, the shared MFP and the authentication device being further configured to encrypt and decrypt data communications.

23. A computer readable medium having machine loadable software for selectively permitting a request for a shared MFP operation, wherein the software is configured to perform a method comprising:
creating at least one profile, each profile comprising information that identifies at least one shared MFP operation permitted to a user;
for each request by the user to execute a shared MFP operation, determining whether the user's profile permits the shared MFP operation.

24. The software of claim 23, wherein creating at least one profile comprises creating user privilege information based on functions and features of a shared MFP with which the software is used.

25. The software of claim 23, wherein creating at least one profile comprises inputting user identification information in at least one format selected from the group consisting of text, image, and sound.

26. The software of claim 23, the method further comprising notifying the shared MFP of a result of the determination of at least one of: (1) whether the user is authorized and (2) whether the shared MFP operation is permitted.

27. The software of claim 23, wherein the software is installable and executable in a computer connected to the office machine.

28. The software of claim 23, wherein the software is installable and executable in the shared MFP.

29. A method of restricting access to a shared printing device, the method comprising:
providing a profile that identifies at least one shared printing device operation permitted to a user;
receiving a request from the user to execute a shared printing device operation;
determining whether the user's profile permits the shared printing device operation; and
if the shared printing device operation is permitted to the user, instructing the shared printing device to execute the shared printing device operation.
